(19) United States
(12) Patent Application Publication
(10) Pub. No.: US 2024/0060411 A1
(43) Pub. Date: Feb. 22, 2024

(54) PHOTOLYTIC CONVERSION OF HYDROGEN SULFIDE IN A GAS MIXTURE PRODUCED BY A HYDROCARBON PRODUCING WELL AND/OR A GAS TREATMENT UNIT

(71) Applicant: Saudi Arabian Oil Company, Dhahran (SA)

(72) Inventors: Adrian Cesar Cavazos Sepulveda, Nuevo Leon (MX); Damian Pablo San Roman Alerigi, Al-Khobar (SA)

(21) Appl. No.: 17/889,517

(22) Filed: Aug. 17, 2022

(51) Int. Cl. E21B 43/34; B01J 19/12; B01J 19/24

(52) U.S. Cl. CPC E21B 43/34; B01J 19/123; B01J 19/2415; B01J 2219/1203; B01J 2219/0892; B01J 2219/0875

(57) ABSTRACT

The disclosure relates to systems and methods to photolytically cleave hydrogen sulfide (H₂S) present in a gas mixture produced by a hydrocarbon producing well and/or a gas treatment unit, thereby converting the hydrogen sulfide to hydrogen gas (H₂) and a sulfur species (e.g., elemental sulfur, polysulfides, and/or organosulfur compounds). This reduces the amount of hydrogen sulfide present in the gas mixture. The systems and methods can be implemented in a component of a hydrocarbon producing well (e.g., a wellhead, a flow line, a production casing, a production tubing), a component used to transport the gas mixture produced by the well (e.g., a transportation pipeline, an inlet to a gas-oil separation plant), and/or a gas treatment unit (e.g., a tail gas treatment unit). The gas mixture is disposed in an annular space of the component(s), and an ultraviolet (UV) light source delivers UV light to the gas mixture to photolytically cleave the hydrogen sulfide.

### FIELD

The disclosure relates to systems and methods to photolytically cleave hydrogen sulfide (H₂S) present in a gas mixture produced by a hydrocarbon producing well and/or a gas treatment unit, thereby converting the hydrogen sulfide to hydrogen gas (H₂) and a sulfur species (e.g., elemental sulfur, polysulfides, and/or organosulfur compounds). This reduces the amount of hydrogen sulfide present in the gas mixture. The systems and methods can be implemented in a component of a hydrocarbon producing well (e.g., a wellhead, a flow line, a production casing, a production tubing), a component used to transport the gas mixture produced by the well (e.g., a transportation pipeline, an inlet to a gas-oil separation plant), and/or a gas treatment unit (e.g., a tail gas treatment unit). The gas mixture is disposed in an annular space of the component(s), and an ultraviolet (UV) light source delivers UV light to the gas mixture to photolytically cleave the hydrogen sulfide.

### BACKGROUND

It is common for a well to produce a gas mixture containing hydrocarbons (e.g., methane, ethane, butane, propane), as well as one or more additional constituents, such as hydrogen sulfide. The hydrogen sulfide can cause corrosion of one or more components of the well or one or more components used to transport the hydrocarbon-containing gas mixture. Therefore, it is generally desirable to reduce the amount of hydrogen sulfide in the gas mixture. Catalysts have been used to try to achieve this goal.

### SUMMARY

The disclosure relates to systems and methods to photolytically cleave hydrogen sulfide (H₂S) present in a gas mixture produced by a hydrocarbon producing well and/or a gas treatment unit, thereby converting hydrogen sulfide to hydrogen gas (H₂) and a sulfur species (e.g., elemental sulfur, polysulfides, and/or organosulfur compounds). This reduces the amount of hydrogen sulfide present in the gas mixture. The systems and methods can be implemented in a component of a hydrocarbon producing well (e.g., a wellhead, a flow line, a production casing, a production tubing), a component used to transport the gas mixture produced by the well (e.g., a transportation pipeline, an inlet to a gas-oil separation plant), and/or a gas treatment unit (e.g., a tail gas treatment unit). The gas mixture is disposed in an annular space of the component(s), and an ultraviolet (UV) light source delivers UV light to the gas mixture to photolytically cleave the hydrogen sulfide.

In certain known methods, catalysts (e.g., photocatalysts) are disposed in the hydrocarbon producing well to remove hydrogen sulfide. However, in such methods, the catalyst can degrade over time (e.g., due to photobleaching) and lose its efficiency. As a result, these methods can involve interventions to replace the catalyst. Such interventions can pose significant costs and/or safety hazards. In contrast, the systems and methods of the disclosure can be implemented with relatively few (if any) well interventions. In some embodiments, the systems and methods of the disclosure can be implemented without using a catalyst (e.g., a photocatalyst).

More generally, the systems and methods of the disclosure can be implemented with relatively small modifications to existing infrastructure, can increase the lifetime of materials, reduce component maintenance, reduce costs and/or risks related to maintenance and/or damage associated with corrosion due to hydrogen sulfide, reduce (e.g., avoid) well interventions relative to certain other methods for addressing hydrogen sulfide reduction, and/or reduce (e.g., avoid) costs and/or safety risks associated with a well intervention.

The systems and methods of the disclosure can remove hydrogen sulfide with little (if any) precipitation and/or deposition of the reaction products. As an example, the systems and methods of the disclosure can generate hydrogen gas and a sulfur species (e.g., elemental sulfur, polysulfides, and/or organosulfur compounds) upon the photocleavage of hydrogen sulfide, for example, in mildly sour wells (relatively low hydrogen sulfide concentration in the hydrocarbon-containing gas mixture). In a mildly sour well, the concentration of the sulfur species (e.g., elemental sulfur, polysulfides, and/or organosulfur compounds) may be sufficiently low such that it is soluble in a component of the produced hydrocarbon-containing gas mixture (e.g., methane, carbon dioxide and/or hydrogen sulfide). Under such conditions, a sulfur purge can be avoided. At higher hydrogen sulfide concentrations, one or more sulfur purge systems can be used to remove the sulfur species (e.g., elemental sulfur, polysulfides, and/or organosulfur compounds) from the produced hydrocarbon-containing gas mixture to reduce (e.g., avoid) precipitation and/or deposition of sulfur species (e.g., elemental sulfur, polysulfides, and/or organosulfur compounds) within the well and/or related systems. Because the solubility of the sulfur species (e.g., elemental sulfur, polysulfides, and/or organosulfur compounds) in the components of the hydrocarbon-containing gas mixture generally increases with temperature, the sulfur purge system(s) can contain one or more heating devices. Further, the recombination of hydrogen gas and sulfur species (e.g., elemental sulfur, polysulfides, and/or organosulfur compounds) has disfavored kinetics under typical temperature and pressure conditions of the hydrocarbon-containing gas mixture. This can enable a flow line and/or component to transport the hydrocarbon-containing gas mixture with little (if any) recombination of the sulfur species (e.g., elemental sulfur, polysulfides, and/or organosulfur compounds) and hydrogen gas.

In a first aspect, the disclosure provides a system, including at least one component of a hydrocarbon producing well, at least one component configured to transport a hydrocarbon produced by a hydrocarbon producing well and/or a gas treatment unit, the member includes an interior space, a gas mixture including hydrogen sulfide disposed in the interior space of the member, and an ultraviolet (UV) light source configured to deliver ultraviolet (UV) light to the gas mixture to photolytically cleave the hydrogen sulfide.

In some embodiments, the member includes a wellhead, a flow line, a production casing, a production tubing, a transportation pipeline, an inlet to a gas-oil separation plant and/or a tail gas treatment unit.

In some embodiments, the ultraviolet light source is configured to deliver the UV light perpendicular to a direction of flow of the gas mixture within the interior space.

In some embodiments, the interior space includes an annular region.

In some embodiments, the system includes a reflective material configured to reflect the UV light after it has traversed at least a portion of the gas mixture causing it to traverse at least a portion of the gas mixture a second time.

In some embodiments, the system includes a sulfur purge configured to remove a sulfur-containing product of the hydrogen sulfide photolysis from the system.

In some embodiments, the UV light source includes a window having anti-reflectivity, transmissibility, self-cleaning, photonic resonance, plasmonic resonance and/or catalytic properties.

In some embodiments, the UV light source includes a window, the window includes a self-cleaning coating, and the self-cleaning coating includes diamond, silica, sulfides, PVDF, nitrides, carbides, fluoride and/or titanate nanofilms.

In a second aspect, the disclosure provides a system, including a first photolytic reactor tube including a first gas inlet, a first gas outlet in fluid communication with the first gas inlet, and an ultraviolet (UV) light source configured to generate ultraviolet (UV) light and a sulfur purge unit, including a sulfur inlet, a heat source, and a sulfur outlet. The UV light source is configured to expose a gas including hydrogen sulfide in the first photolytic reactor tube to UV light generated by the UV light source so that the UV light cleaves the hydrogen sulfide to produce hydrogen gas and a sulfur-containing product. The sulfur purge unit is in fluid communication with the first gas outlet and the sulfur purge unit is configured to remove the sulfur-containing product from the system.

In certain embodiments, the sulfur purge unit is configured so that, during use of the sulfur purge unit, the sulfur-containing product enters the sulfur purge unit via the sulfur inlet, is heated by the heat source to at least partially liquefy the sulfur-containing product, and the sulfur-containing product leaves the system through the sulfur outlet.

In certain embodiments, the first gas inlet is configured to be in fluid communication with a hydrocarbon-containing gas mixture produced by a well, the first gas outlet is in fluid communication with at least one component configured to transport the gas mixture, and when the gas mixture contains hydrogen sulfide, the UV light hydrolyzes the hydrogen sulfide to remove hydrogen sulfide from the gas mixture.

In certain embodiments, the first photolytic reactor tube includes a plurality of UV light sources.

In certain embodiments, the system includes a second photolytic reactor tube including a second gas inlet, a second gas outlet in fluid communication with the second gas inlet, and a second UV light source configured to generate UV light, wherein the second UV light source is configured to expose a hydrogen sulfide-containing gas in the second photolytic reactor tube to UV light generated by the second UV light source so that the UV light cleaves the hydrogen sulfide to produce hydrogen gas and the sulfur-containing product.

In certain embodiments, the system includes a second sulfur purge unit in fluid communication with the second gas outlet, wherein the second sulfur purge unit is configured to remove the sulfur-containing product produced in the second photolytic reactor tube from the system.

In certain embodiments, the gas inlet is in fluid communication with at least one component of a hydrocarbon producing well.

In certain embodiments, the gas outlet is in fluid communication with a component to transport a hydrocarbon.

In a third aspect, the disclosure provides a method, including using ultraviolet (UV) light to hydrolyze hydrogen sulfide in a first gas mixture produced by a hydrocarbon producing well while the first gas mixture is disposed in an interior space of at least one component of a hydrocarbon producing well, at least one component configured to transport a hydrocarbon produced by a hydrocarbon producing well, and/or a gas treatment unit, thereby photolytically cleaving the hydrogen sulfide to remove at least some of the hydrogen sulfide from the first gas mixture to produce a second gas mixture. The first gas mixture includes a hydrocarbon and/or carbon dioxide

In some embodiments, the member includes a wellhead, a flow line, a production casing, a production tubing, a transportation pipeline, an inlet to a gas-oil separation plant, and/or a tail gas treatment unit.

In some embodiments, the photolytic cleavage of the hydrogen sulfide produces a sulfur-containing product, and the method further includes removing the sulfur-containing product from the member.

In some embodiments, the method includes transporting the second gas mixture to a downstream system.

### BRIEF DESCRIPTION OF THE FIGURES

FIG. 1 schematically depicts some components of an embodiment of a system.

FIG. 2 schematically depicts some components of an embodiment of a system.

FIG. 3 schematically depicts a system that includes a hydrocarbon-producing well.

### DETAILED DESCRIPTION

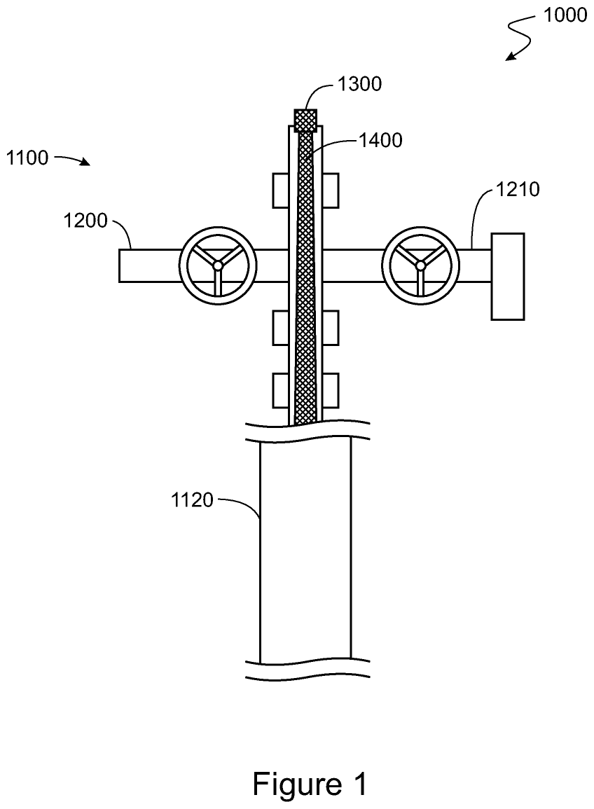

FIG. 1 schematically depicts a system 1000 that includes a well 1100 having a wellhead 1110 in fluid communication with a casing 1120. The wellhead 1110 includes a first valved section 1200 and a second valved section 1210. The sections 1200 and 1210 can be used, for example, to deliver a fluid into the well casing 1120. A UV light source 1300 is mounted on the wellhead 1110. A hydrocarbon-containing gas mixture is present in the region 1400 of the wellhead 1110. In addition to one or more hydrocarbons (e.g., methane, ethane, propane, butane), the hydrocarbon-containing gas mixture contains hydrogen sulfide and optionally one or more constituents, such as carbon dioxide. The UV light 1300 source delivers UV light to the region 1400, which photolytically cleaves hydrogen sulfide in the region 1400, generating sulfur species (e.g., elemental sulfur, polysulfides, and/or organosulfur compounds) and hydrogen gas, thereby reducing the amount of hydrogen sulfide contained in the hydrocarbon-containing gas mixture.

Generally, the positioning, alignment and number of the UV light source 1300 may be selected as appropriate to photolytically cleave the hydrogen sulfide in the region 1400. Thus, while FIG. 1 depicts a certain location of the UV light source 1300, the disclosure is not limited to such an arrangement. As an example, in some embodiments, the UV light source 1300 is along a flow line such that UV light is delivered to a hydrocarbon-containing gas mixture in the flow line such that hydrogen sulfide present in the gas mixture is photolytically cleaved to generate sulfur species (e.g., elemental sulfur, polysulfides, and/or organosulfur compounds) and hydrogen. Further, while FIG. 1 shows a single UV light source 1300, the disclosure is not limited to embodiments in which a single UV light source is used. Moreover, the number of UV light sources can be selected as appropriate. Therefore, in some embodiments, multiple (e.g., two, three, four, five, more than five) UV light sources are used. In addition, in embodiments in which multiple light sources are used, the light sources can be used in series along a hydrocarbon flow path. Moreover, in such embodiments, the light sources can be used simultaneously or at different times. In some embodiments, preferred configurations of the UV light source 1300 are those with the longest unobstructed path for the UV light. Without wishing to be bound by theory, it is believed that such a configuration maximizes the absorption of the UV light by hydrogen sulfide rather than surfaces and/or components of the well. Without wishing to be bound by theory, it is believed to be preferential for the photolytic cleavage of hydrogen sulfide to occur as far as possible from the UV light source 1300 to reduce (e.g., prevent) deposition on or near the UV light source 1300. In general, the UV light source 1300 can be any coherent or incoherent UV light source. Examples of UV light sources include light emitting diodes (LEDs), superluminescent diodes (SLEDs), lasers and solar concentrators. Without wishing to be bound by theory, it is believed that solid-state light sources are well suited for use in the systems and methods of the disclosure due to their relatively high wall plug to light efficiency and being less prone to damage relative to other light sources (e.g., evacuated bulbs).

In some embodiments, the wavelength of the UV light source is at least 100 (e.g., at least 125, at least 280) nanometers (nm) and at most 380 (e.g., at most 315, at most 280) nm. In some embodiments, the wavelength does not cause methane photolysis. Generally, the power is determined by the concentration of hydrogen sulfide and the gas flow rate. In some embodiments, the UV light source has an intensity of at least 1 milliwatt (e.g. at least 1 watt, at least 1 kilowatt) and at most 1 megawatt (e.g. at most 1 kilowatt, at most 1 watt).

In general, the UV light source can be used with any appropriate optical components. As an example, the UV light source 1300 can be used in combination with lenses, optical fibers (e.g. solid-core optical fibers, hollow-core optical fibers), electromagnetic waveguides, mirror and/or meta-surfaces. In certain embodiments, the UV light source 1300 can be used in combination with lenses and/or metasurfaces to create non-Gaussian self-healing beams with low angular spreading (e.g., Bessel or Airy beams). In certain embodiments, the optical elements are placed external to a component of a hydrocarbon producing well (e.g., a wellhead, a flow line, a production casing, a production tubing), a component used to transport the gas mixture produced by the well (e.g., a transportation pipeline, an inlet to a gas-oil separation plant), and/or a gas treatment unit (e.g., a tail gas treatment unit) to reduce (e.g., prevent) the need for a well intervention.

In some embodiments, the UV light source 1300 can be used with a UV window. In some embodiments, the UV window contains a self-cleaning element or property. In some embodiments, the self-cleaning element is hydrophobic material, a super hydrophobic material, an oleophobic material, a super oleophobic material, an omniphobic material and/or a super omniphobic material. In some embodiments, the self-cleaning element contains diamond, silica, sulfides, polyvinylidene fluoride (PVDF), nitride, carbide, fluoride and/or titanate nanofilms. In certain embodiments, the UV window is modified to provide one or more desirable properties. In certain embodiments, the desirable property is anti-reflectivity, transmissibility, self-cleaning, photonic resonance, plasmonic resonance and/or catalytic properties. In certain embodiments, the modification involves adding at least one layer to the UV window.

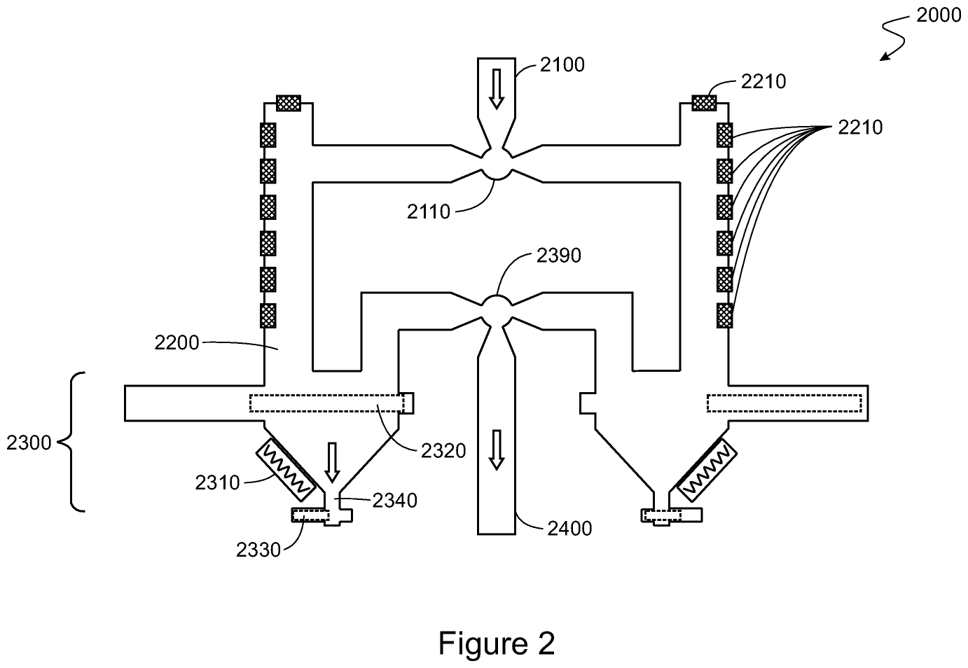

FIG. 2 depicts a system 2000. The system 2000 includes a gas inlet 2100, photolytic reactor tubes 2200, sulfur purges 2300 and a gas outlet 2400. A gas mixture containing a hydrocarbon hydrogen sulfide enters the system 2000 through the gas inlet 2100. A three-way valve 2110 connects the gas inlet 2100 and the photolytic reactor tubes 2200. The gas mixture traverses the photolytic reactor tubes 2200. The photolytic reactor tubes 2200 contain UV light sources 2210 configured to deliver UV light to the interior of the photolytic reactor tubes 2200 to photolytically cleave the hydrogen sulfide in the gas mixture to form sulfur species (e.g., elemental sulfur, polysulfides, and/or organosulfur compounds) and hydrogen.

Without wishing to be bound by theory, it is believed that at relatively high concentrations of hydrogen sulfide, the solubility of sulfur species (e.g., elemental sulfur, polysulfides, and/or organosulfur compounds) generated from the photolytic cleavage of hydrogen sulfide can potentially become so large that the sulfur species (e.g., elemental sulfur, polysulfides, and/or organosulfur compounds) formed may not undergo complete dissolution in the hydrocarbon-containing gas mixture, thereby potentially resulting in precipitation and/or deposition of the sulfur species (e.g., elemental sulfur, polysulfides, and/or organosulfur compounds) within the well and/or components used to transport the hydrocarbon-containing gas mixture. The system 2000 is configured so that the sulfur species (e.g., elemental sulfur, polysulfides, and/or organosulfur compounds) that is not soluble in the hydrocarbon-containing gas mixture collects in the sulfur purges 2300. In some embodiments, traces of methane and/or other light hydrocarbons may also collect in the sulfur purges 2300. The sulfur purges contain a heat source 2310, a first actuator valve 2320, a second actuator valve 2330, and a sulfur outlet 2340. The first actuator valve 2320 can open to allow precipitated sulfur species (e.g., elemental sulfur, polysulfides, and/or organosulfur compounds) to flow to a region adjacent the heater 2310. When adjacent the heater 2310, the precipitated sulfur species (e.g., elemental sulfur, polysulfides, and/or organosulfur compounds) is converted to a liquid and/or semi-liquid. The second actuator valve 2330 can open to allow the liquid and/or semi-liquid sulfur species (e.g., elemental sulfur, polysulfides, and/or organosulfur compounds) to exit the system 2000 by flowing through the outlet 2340. The hydrocarbon-containing gas mixture exits the system 2000 via the outlet 2400. A three-way valve 2390 connects the gas outlet 2400 and the photolytic reactor tubes 2200. In some embodiments, the liquid and/or semi-liquid sulfur species (e.g., elemental sulfur, polysulfides, and/or organosulfur compounds) are removed from the system 2000 without gas leakage. In some embodiments, the first actuator valve 2320 is closed when the second actuator valve 2330 is opened. In some embodiments, when the second actuator valve 2330 is opened, the three way valves 2110 and 2390 are used to divert flow to the other flow path.

In general, the various components of the system 2000 can be oriented as appropriate. As shown in FIG. 2, in some embodiments, at least a portion of the system 2000 is oriented horizontally, vertically and/or diagonally. In some embodiments, the gas inlet 2100 is in fluid communication with a component of a hydrocarbon producing well (e.g., a well head, a flow line, a producing casing, a production tubing), a component to transport a hydrocarbon (e.g., a transportation pipeline, an inlet to a gas-oil separation plant), and/or a tail gas treatment system for a sulfur recovery unit. In some embodiments, the gas outlet 2400 is in fluid communication with a component to transport a hydrocarbon (e.g., a transportation pipeline, an inlet to a gas-oil separation plant), a tail gas treatment system for a sulfur recovery unit, and/or an exhaust.

In certain embodiments, the system 1000 and/or the system 2000 can further include one or more UV reflecting surfaces. In some embodiments, the UV reflecting surfaces contain polytetrafluoroethylene (PTFE), polyvinylidene fluoride (PVDF), polychlorotrifluoroethylene (PCTFE), aluminum and/or stainless steel. Without wishing to be bound by theory, it is believed that the UV reflecting surfaces can be used to increase the path length of the UV light and increase the contact time of the UV light with the gas mixture thereby increasing the amount of photolytic cleavage of hydrogen sulfide relative to the absence of the UV reflecting surfaces. For example, in some embodiments, it is believed that the UV reflecting surface(s) can allow the UV light to pass through the gas mixture multiple times. In some embodiments, the UV reflecting surfaces can create a resonating cavity lengthwise or through the entire body of the system 2000. Additional parallelization and/or miniaturization within the photolytic reactor tubes 2200 is possible.

In general, the heat source 2310 is configured to heat the sulfur species (e.g., elemental sulfur, polysulfides, and/or organosulfur compounds) so that it becomes a liquid and/or semi-liquid. In some embodiments, the heat source 2310 heats the sulfur species (e.g., elemental sulfur, polysulfides, and/or organosulfur compounds) to a temperature of at least 110 (e.g. at least 115, at least 120) ° C. and at most 450 (e.g. at most 444, at most 440) ° C.

In some embodiments, the system 2000 can further include one or more sensors to monitor one or more parameters of interest, such as, for example, the sulfur species (e.g., elemental sulfur, polysulfides, and/or organosulfur compounds) level of the sulfur purge 2300. As an example, such sensors could be used to determine when to switch between different sulfur purges (e.g., left sulfur purge or right sulfur purge as depicted in FIG. 2), when to initiate and finalize the sulfur species (e.g., elemental sulfur, polysulfides, and/or organosulfur compounds) discharge, the composition of the fluid and/or the sulfur species present.

In certain embodiments, the sulfur outlet 2340 has a “U” shaped trap. Without wishing to be bound by theory, it is believed that the “U” shaped trap can reduce (e.g., prevent) gas discharges into subsequent containers, such as, for example, those present in a gas-oil separation plant. In certain embodiments, the sulfur outlet 2340 is connected to a sulfur pit.

Further sulfur species (e.g., elemental sulfur, polysulfides, and/or organosulfur compounds) separation techniques may be employed. As an example, such techniques can be employed to provide laminar flow and/or reduce recombination rates of the hydrogen gas and sulfur species (e.g., elemental sulfur, polysulfides, and/or organosulfur compounds) to reform hydrogen sulfide.

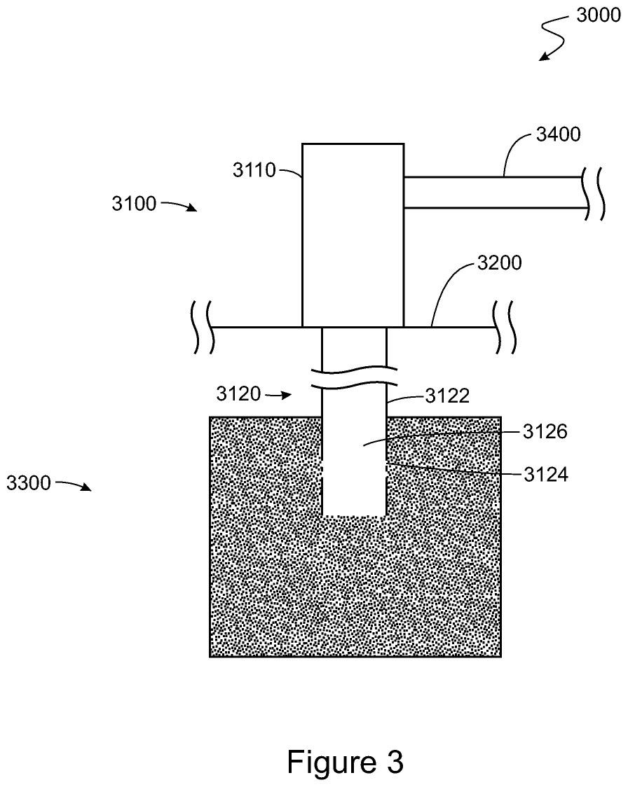

FIG. 3 schematically depicts a system 3000 that includes a hydrocarbon-producing (e.g., hydrocarbon-containing gas mixture) well 3100 having a first portion 3110 above a surface of the earth 3200 and a second portion 3120 that extends below the surface 3200 and into an underground formation 3300. The portion 3120 includes a casing 3122 having perforations 3124. The well 3100 is designed so that the perforations 3124 allow for fluid communication between an interior region 3126 of the casing 3122 and the underground formation 3300. The hydrocarbon producing well 3100 include a pipe 3400 enabling the hydrocarbon-containing gas mixture produced by the well 3100 to be transported from the well for subsequent storage and/or processing.

A UV light source can be configured (e.g., as discussed above) to deliver UV light to the interior of the portion 3110 (e.g., a wellhead), the interior of the portion 3120 (e.g., the casing 3122, a production tubing), and/or the interior of the pipe 3400, so that the UV light photolytically cleaves hydrogen sulfide present in the hydrocarbon-containing gas mixture, generating sulfur species (e.g., elemental sulfur, polysulfides, and/or organosulfur compounds) and hydrogen gas, thereby reducing the amount of hydrogen sulfide contained in the hydrocarbon-containing gas mixture.

### OTHER EMBODIMENTS

While certain embodiments have been disclosed above, the disclosure is not limited to such embodiments.

As an example, while embodiments have been disclosed that include systems and methods related to hydrocarbon production, the disclosure is not limited to such embodiments. In some embodiments, the systems and methods of the disclosure can be used in sewage and/or metallurgy applications.

As another example, while FIG. 2 depicts an embodiment including sulfur purges, the disclosure is not limited in this sense. More generally, a system having a different configuration can include one or more sulfur purges. As an example, in some embodiments, the system depicted in FIG. 1 can further include a sulfur purge. As a further example, in certain embodiments, one or more components of a hydrocarbon producing well (e.g., a wellhead, a flow line, a production casing, a production tubing), one or more components used to transport the gas mixture produced by the well (e.g., a transportation pipeline, an inlet to a gas-oil separation plant), and/or a gas treatment unit (e.g., a tail gas treatment unit) can include one or more sulfur purges.

As an additional example, while embodiments have been disclosed in which a system and/or method does not use a catalyst (e.g., a photocatalyst), the disclosure is not limited to such embodiments. Rather, in some embodiments, the systems and methods of the disclosure can further include a catalyst (e.g. a photocatalyst) to assist in the cleavage of H₂S.

As a further example, while embodiments have been described involving a hydrocarbon gas, in some embodiments, the gas mixture can contain carbon dioxide in addition to, or instead of, hydrocarbon gas.

What is claimed:

1. A system, comprising:
a member selected from the group consisting of at least one component of a hydrocarbon producing well, at least one component configured to transport a hydrocarbon produced by a hydrocarbon producing well and a gas treatment unit, the member comprising an interior space;
a gas mixture comprising hydrogen sulfide, the gas mixture being disposed in the interior space of the member; and
an ultraviolet (UV) light source configured to deliver ultraviolet (UV) light to the gas mixture to photolytically cleave the hydrogen sulfide.

2. The system of claim 1, wherein the member comprises at least one component selected from the group consisting of a wellhead, a flow line, a production casing, a production tubing, a transportation pipeline, an inlet to a gas-oil separation plant and a tail gas treatment unit.

3. The system of claim 1, wherein the ultraviolet light source is configured to deliver the UV light perpendicular to a direction of flow of the gas mixture within the interior space.

4. The system of claim 1, wherein the interior space comprises an annular region.

5. The system of claim 1, further comprising a reflective material configured to reflect the UV light after it has traversed at least a portion of the gas mixture causing it to traverse at least a portion of the gas mixture a second time.

6. The system of claim 1, further comprising a sulfur purge configured to remove a sulfur-containing product of the hydrogen sulfide photolysis from the system.

7. The system of claim 1, wherein the UV light source comprises a window having at least one property selected from the group consisting of anti-reflectivity, transmissibility, self-cleaning, photonic resonance, plasmonic resonance and catalytic properties.

8. The system of claim 1, wherein the UV light source comprises a window, the window comprises a self-cleaning coating, and
the self-cleaning coating comprises a member selected from the group consisting of diamond, silica, sulfides, PVDF, nitrides, carbides, fluoride and titanate nanofilms.

9. A system, comprising:
a first photolytic reactor tube comprising a first gas inlet, a first gas outlet in fluid communication with the first gas inlet, and an ultraviolet (UV) light source configured to generate ultraviolet (UV) light; and
a sulfur purge unit, comprising a sulfur inlet, a heat source, and a sulfur outlet
wherein:
the UV light source is configured to expose a gas comprising hydrogen sulfide in the first photolytic reactor tube to UV light generated by the UV light source so that the UV light cleaves the hydrogen sulfide to produce hydrogen gas and a sulfur-containing product;
the sulfur purge unit is in fluid communication with the first gas outlet; and
the sulfur purge unit is configured to remove the sulfur-containing product from the system.

10. The system of claim 9, wherein the sulfur purge unit is configured so that, during use of the sulfur purge unit, the sulfur-containing product enters the sulfur purge unit via the sulfur inlet, is heated by the heat source to at least partially liquefy the sulfur-containing product, and the sulfur-containing product leaves the system through the sulfur outlet.

11. The system of claim 9, wherein:
the first gas inlet is configured to be in fluid communication with a hydrocarbon-containing gas mixture produced by a well;
the first gas outlet is in fluid communication with at least one component configured to transport the gas mixture; and
when the gas mixture contains hydrogen sulfide, the UV light hydrolyzes the hydrogen sulfide to remove hydrogen sulfide from the gas mixture.

12. The system of claim 9, wherein the first photolytic reactor tube comprises a plurality of UV light sources.

13. The system of claim 9, further comprising a second photolytic reactor tube comprising a second gas inlet, a second gas outlet in fluid communication with the second gas inlet, and a second UV light source configured to generate UV light, wherein the second UV light source is configured to expose a hydrogen sulfide-containing gas in the second photolytic reactor tube to UV light generated by the second UV light source so that the UV light cleaves the hydrogen sulfide to produce hydrogen gas and the sulfur-containing product.

14. The system of claim 13, further comprising a second sulfur purge unit in fluid communication with the second gas outlet, wherein the second sulfur purge unit is configured to remove the sulfur-containing product produced in the second photolytic reactor tube from the system.

15. The system of claim 9, wherein the gas inlet is in fluid communication with at least one component of a hydrocarbon producing well.

16. The system of claim 9, wherein the gas outlet is in fluid communication with a component to transport a hydrocarbon.

17. A method, comprising:
using ultraviolet (UV) light to hydrolyze hydrogen sulfide in a first gas mixture produced by a hydrocarbon producing well while the first gas mixture is disposed in an interior space of a member selected from the group consisting of at least one component of a hydrocarbon producing well, at least one component configured to transport a hydrocarbon produced by a hydrocarbon producing well, and a gas treatment unit, thereby photolytically cleaving the hydrogen sulfide to remove at least some of the hydrogen sulfide from the first gas mixture to produce a second gas mixture
wherein the first gas mixture comprises at least one member selected from the group consisting of a hydrocarbon and carbon dioxide.

18. The method of claim 17, wherein the member comprises at least one component selected from the group consisting of a wellhead, a flow line, a production casing, a production tubing, a transportation pipeline, an inlet to a gas-oil separation plant, and a tail gas treatment unit.

19. The method of claim 17, wherein the photolytic cleavage of the hydrogen sulfide produces a sulfur-containing product, and the method further comprises removing the sulfur-containing product from the member.

20. The method of claim 17, further comprising transporting the second gas mixture to a downstream system.
